(19) United States
(12) Patent Application Publication
(10) Pub. No.: US 2003/0182256 A1
(43) Pub. Date: Sep. 25, 2003

(54) Device, system, and method for creating a bill of materials

(76) Inventor: David Otey, Schererville, IN (US)

Correspondence Address: Siemens Corporation, Intellectual Property Department, 186 Wood Avenue South, Iselin, NJ, 08830, US

(21) Appl. No.: 10/105,582

(22) Filed: Mar. 25, 2002

(51) Int. Cl. G06F 7/00

(52) U.S. Cl. 707/1

(57) ABSTRACT

At least one exemplary embodiment of the present invention includes a computer-implemented method for generating a bill of materials for a product. The method can include iteratively determining a plurality of component identifiers from a plurality of sub-identifiers associated with an identifier for a product, each of the plurality of component identifiers associated with a component of the product. The method can also include rendering the iteratively determined plurality of component identifiers.

### BACKGROUND

The present invention relates generally to the field of software, and, in certain embodiments, to a device, system, and computer-implemented method for creating a bill of materials for a product and/or service.

To construct a product, a “bill of materials” that lists the components of the product is often utilized. When the universe of products and components is relatively small, a few lists or a database can be used to generate a bill of materials for each product. As the universe of products and/or their components grows, such lists and databases become cumbersome to use and expensive to maintain.

As an example, consider a refrigerator manufacturer. Each refrigerator that the manufacturer offers can have a large number of features. These features can vary from product to product, and can include, for example, size (e.g., 18, 20, 21, 24, 25, 28, 30, 32, and/or 33 cubic feet), whether the refrigerator has a freezer section, whether the freezer section is top-mounted or bottom-mounted or side-by-side, whether an ice-maker is included, whether ice is provided throught the door, whether water is provided through the door, whether the doors swing left or right, whether the doors are normal depth or extra deep, whether the refrigerator has enhanced energy efficiency, whether the refrigerator has enhanced sound reduction, and/or the refrigerator's color (e.g., white, almond, black, stainless), etc.

Often, both products and their components have catalog numbers, part codes, and/or other sorts of identifications. Such identifiers can include various sub-identifiers that identify values for some of the features from which the components of the product can be chosen.

Returning to the refrigerator example, the values chosen for the refrigerator's variable features can determine the refrigerator's product code. For example, for a 28 cubic foot refrigerator having a top-mounted freezer section, with a through-the-door icemaker and water supply, left-swinging doors, in white, with enhanced energy efficiency and sound reduction, the product code might be 28WAITWLSES. In this exemplary refrigerator product code, the first two characters indicate the refrigerator's size (i.e., 28 cubic feet), the third character indicates the color (i.e., “W” for white), the fourth character indicates the freezer section's location with respect to the refrigerated section's location (i.e., “A” for “above”), the fifth character indicates that an icemaker is included, the sixth character indicates that ice is provided through the door, the seventh character indicates that water is also supplied through the door, the eighth character indicates the door swing (i.e., “L” for hinges on the left when one goes to open the refrigerated section's door), the ninth character indicates doors of standard depth for the refrigerated section, the tenth character indicates the enhanced energy efficiency option, and the eleventh character indicates the enhanced sound reduction feature.

Knowing these variables, certain components for the refrigerator can be chosen, such as the compressor size, the evaporator size, the enclosure size and color, the door sizes and colors, the icemaker mechanism, and/or the number and types of trays, racks, and drawers, the insulation and seal kits, etc. Each of these components can have its own part number.

In the refrigerator example, there might be 15 different variable features (e.g., size, color, door swing, etc.), each having an average of 4 possible values. In this hypothetical case, the number of refrigerator product codes needed to distinguish each possible refrigerator would be 4 raised to the 15th power, or 1,073,741,824. Thus, over one billion product codes would be required to describe all possible refrigerators. Moreover, each of these product codes would have numerous associated component part codes. If these component part codes were to be provided in a standard database, the database likely would be huge, expensive, slow, and difficult to update and/or maintain. Moreover, providing a bill of materials listing all the components needed o build each refrigerator would be similarly challenging. Such data challenges might drive the manufacturer to limit the number of features offered, thereby preventing the manufacturer from offering as many features as consumers might prefer.

### SUMMARY

At least one exemplary embodiment of the present invention includes a computer-implemented method for generating a bill of materials for a product. The method can include iteratively determining a plurality of component identifiers from a plurality of sub-identifiers associated with an identifier for a product, each of the plurality of component identifiers associated with a component of the product. The method can also include rendering the iteratively determined plurality of component identifiers.

At least one exemplary embodiment of the present invention includes a computer-implemented method for generating a list of components associated with an item. The method can include iteratively determining a plurality of components of an item from an identification number associated with the item. The method also can include rendering the iteratively determined plurality of components.

### BRIEF DESCRIPTION OF DRAWINGS

The invention and its wide variety of potential embodiments will be more readily understood through the following detailed description, with reference to the accompanying drawings in which:

FIG. 1 is a flow diagram of an exemplary embodiment of a method 100;

FIG. 2 is a diagram of an exemplary embodiment of a user interface 200;

FIG. 3 is a diagram of an exemplary embodiment of a multi-variable table 300 after reduction by several iterations;

FIG. 4 is a diagram of an exemplary embodiment of a table 400 after reduction of table 300 by one iteration;

FIG. 5 is a diagram of an exemplary embodiment of a table 500 after reduction of table 400 by one iteration;

FIG. 6 is a diagram of an exemplary embodiment of a table 600 after reduction of table 500 by one iteration; and

FIG. 7 is a diagram of an exemplary embodiment of an apparatus 700.

FIG. 8 is a diagram of an exemplary embodiment of the apparatus 700 receiving instructions over the Internet from an apparatus 810.

### DETAILED DESCRIPTION

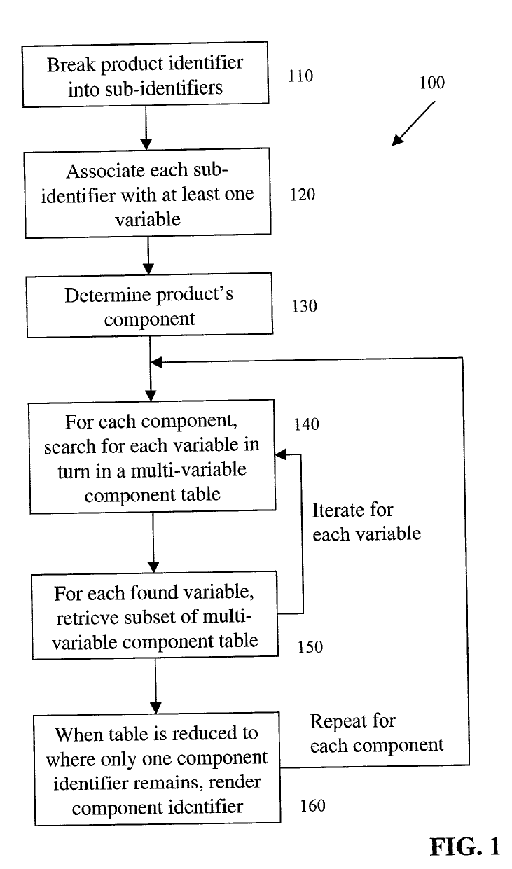

FIG. 1 is a flow diagram of an exemplary embodiment of a method 100 of the present invention. Method 100 can be implemented, for example, using Excel spreadsheets.

At activity 110, the product identifier can be broken into sub-identifiers. Returning to the refrigerator example, the hypothetical product identifier 28WAITWLSES could be broken into “28”, “W”, “A”, “I”, “T”, “W”, “L”, “S”, “E”, and “S”.

At activity 120, each sub-identifier can be associated with at least one variable or feature. Using the refrigerator example, the sub-identifier (and/or value) “28” could be associated with the variable “Size”, the sub-identifier “W” could be associated with the variable “Color”, the sub-identifier “A” could be associated with the variable “Freezer location”, the sub-identifier “I” could be associated with the variable “Icemaker included?”, etc.

At activity 130, the types of components that are needed to build the product can be determined. Using the refrigerator example, it can be determined, perhaps from a list or a simple database, that each refrigerator must have at least an enclosure, doors, a compressor, an evaporator, an insulation kit, a door seal kit, etc.

At activity 140, for each of the determined components, one of the many variables can be selected to begin the process of determining the identifier of that component, or for perhaps several components simultaneously. For example, the variable can be the first (or any other) variable in the product identifier, which in the refrigerator example is the “Size” variable. A multi-variable table can be searched for the value corresponding to this variable. That is, a multi-variable table containing value entries for numerous variables, for example “Refrigerator Size”, “Color”, “Freezer location”, and “Icemaker included” can be searched for value entries corresponding to 28 cubic foot refrigerators.

At activity 150, when the sought value is found in the table, the table can be reduced to eliminate all value entries for that variable that do not correspond to the found value. That is, all entries in the table that do not correspond to 28 cubic foot refrigerators can be eliminated, so that all value entries (such as those for color, door swing, etc.) will be eliminated that are associated with 18, 21, 22, 24, 30, and 31, etc. cubic foot refrigerators. Alternatively, a subset of the multi-variable table, containing only value entries corresponding to 28 cubic foot refrigerators can be created.

Activities 140 and 150 can be repeated for each variable until only single component identifier remains for a given component, such as, for example, a single compressor part number for a refrigerator of the chosen size. At activity 160, this remaining component identifier can be saved and/or rendered by, for example, displaying, announcing, and/or printing the component identifier. Activites 140, 150, and 160 can be repeated for each component of the product.

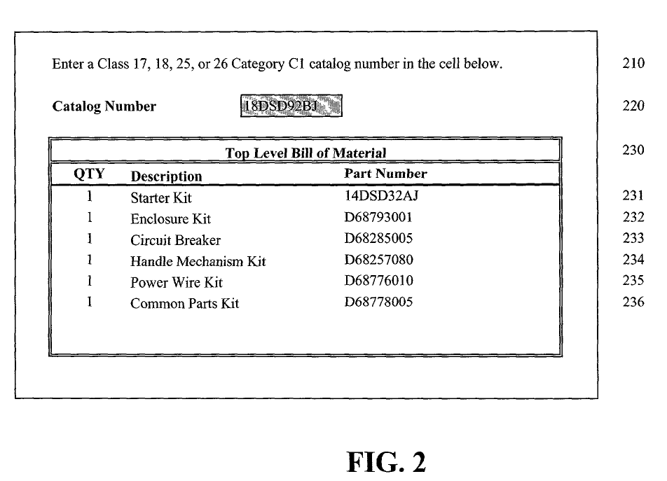

FIG. 2 is a diagram of an exemplary embodiment of a software user interface 200 for method 100, and which provides exemplary data relevant to an electrical starter for a motor, actuator, or the like. User interface element 210 provides instructions to the user. User interface element 220 allows the user to enter a catalog number for the product of interest. Upon providing the catalog number, the software executes and/or runs method 100, and user interface 200 displays a Bill of Materials, which includes the quantity, description, and part number for components of the product corresponding to the catalog identifier. Thus, to build a starter having catalog “number” 18DSD92BJ, one of each of the following parts are needed: starter kit 14DSD32AJ, enclosure kit D68793001, circuit breaker D68285005, handle mechanism kit D68257080, power wire kit D68776010, and common parts kit D68778005. Note that each of these parts can themselves have components, which software according to method 100 can render in a subsidiary bill of materials for each part.

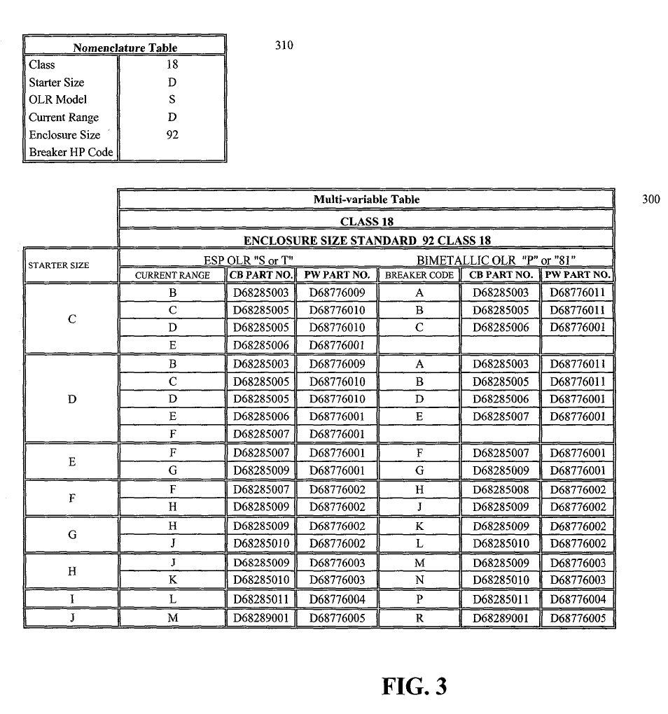

FIG. 3 is a diagram of an exemplary embodiment of a multi-variable table 300 after reduction by several iterations. Also included is a nomenclature table 310, which shows the variables associated with each of the sub-identifiers (which correspond to values) in exemplary catalog number 18DSD92. Note that multi-variable table 300 has already been reduced to reflect that the value and/or sub-identifier of the starter class is 18, and the value and/or sub-identifier of the enclosure size is 92. Note also that table 300 simultaneously presents entries for two components—circuit breaker and power wire, and that numerous entries remain for the circuit breaker's part “number” and for the power wire's part number.

In accordance with exemplary method 100, table 300 can be further reduced, and/or a subset of table 300 can be stored and/or rendered, such that only those entries in table 300 corresponding to starter size D are presented.

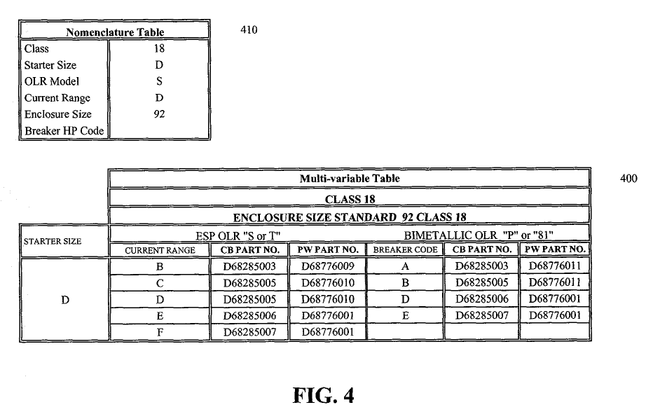

FIG. 4 is a diagram of an exemplary embodiment of a table 400 after reduction of table 300 by one iteration. Also included is nomenclature table 410, which is identical to nomenclature table 310. Note that table 400 only presents entries corresponding to starter size D. Note also that numerous entries remain for the circuit breaker's part number and for the power wire's part number.

In accordance with exemplary method 100, table 400 can be further reduced, and/or a subset of table 400 can be stored and/or rendered, such that only those entries in table 400 corresponding to overload relay type S are presented.

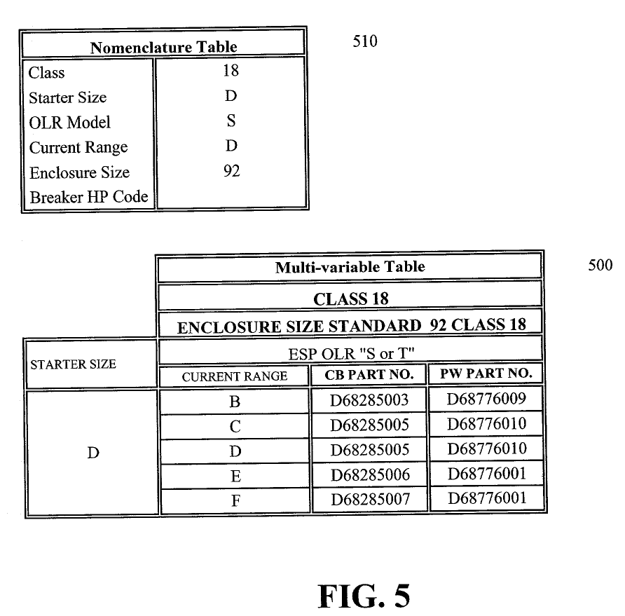

FIG. 5 is a diagram of an exemplary embodiment of a table 500 after reduction of table 400 by one iteration. Also included is nomenclature table 510, which is identical to nomenclature table 510. Note that table 500 only presents entries corresponding to overload relay type S. Note also that numerous entries remain for the circuit breaker's part number and for the power wire's part number.

In accordance with exemplary method 100, table 500 can be further reduced, and/or a subset of table 500 can be stored and/or rendered, such that only those entries in table 500 corresponding to current range D are presented.

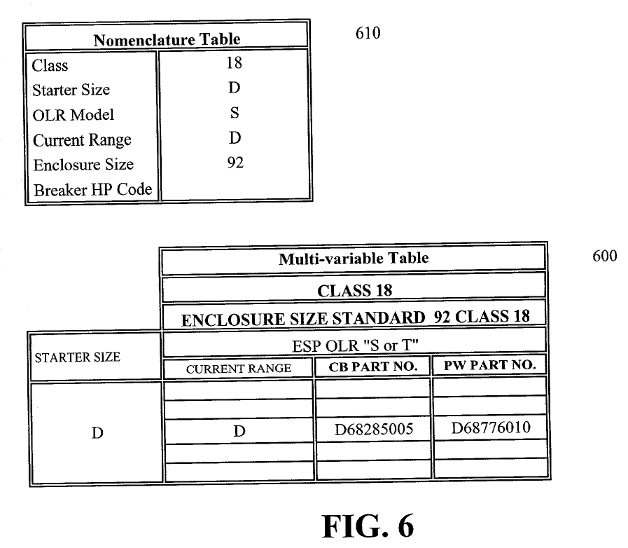

FIG. 6 is a diagram of an exemplary embodiment of a table 600 after reduction of table 500 by one iteration. Also included is nomenclature table 610, which is identical to nomenclature table 510. Note that table 600 only presents entries corresponding to current range D. Note also that only one entry remains for the circuit breaker's part number and for the power wire's part number.

Thus, in accordance with an exemplary embodiment of method 100, circuit breaker part number (identifier) D68285005 and power wire part number D68776010 can be rendered to the user via a user interface, such as is shown in FIG. 2.

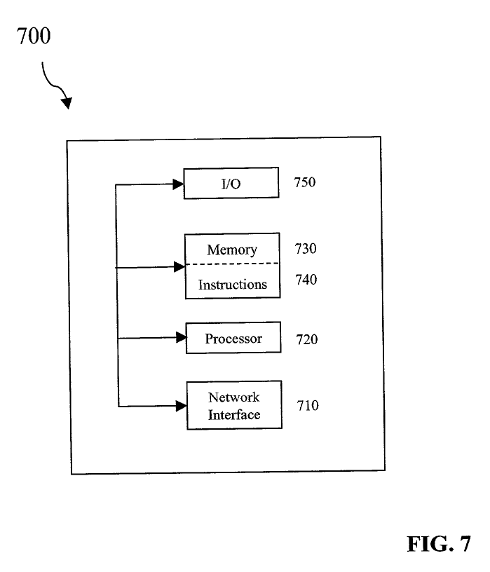

FIG. 7 is a block diagram of an exemplary embodiment of a typical information device 700. Information device 700 can include well-known components such as one or more network interfaces 710, one or more processors 720, one or more memories 730 containing instructions 740, and/or one or more input/output (“I/O”) devices 750.

In one exemplary embodiment, network interface 710 can be a telephone, a traditional data modem, a fax modem, a cable modem, a digital subscriber line interface, a bridge, a hub, a router, or other similar devices.

In one exemplary embodiment, processor 720 can be a general-purpose microprocessor, such a Pentium series microprocessor manufactured by the Intel Corporation of Santa Clara, Calif. In another embodiment, the processor can be an Application Specific Integrated Circuit (ASIC), which has been designed to implement in its hardware and/or firmware at least a part of a method in accordance with an embodiment of the present invention.

In one exemplary embodiment, memory 730 can be coupled to a processor 720 and can store instructions 740 adapted to be executed by processor 720 according to one or more activities of method 100. Memory 730 can be any device capable of storing analog or digital information, such as a hard disk, Random Access Memory (RAM), Read Only Memory (ROM), flash memory, a compact disk, a magnetic tape, a floppy disk, etc., and any combination thereof.

In one exemplary embodiment, instructions 740 can be embodied in software, which can take any of numerous forms that are well known in the art. In one exemplary embodiment, I/O device 750 can be an audio and/or visual device, including, for example, a monitor, display, keyboard, keypad, touch-pad, pointing device, microphone, speaker, video camera, camera, scanner, and/or printer, etc., and can include a port to which an I/O device can be attached, connected, and/or coupled.

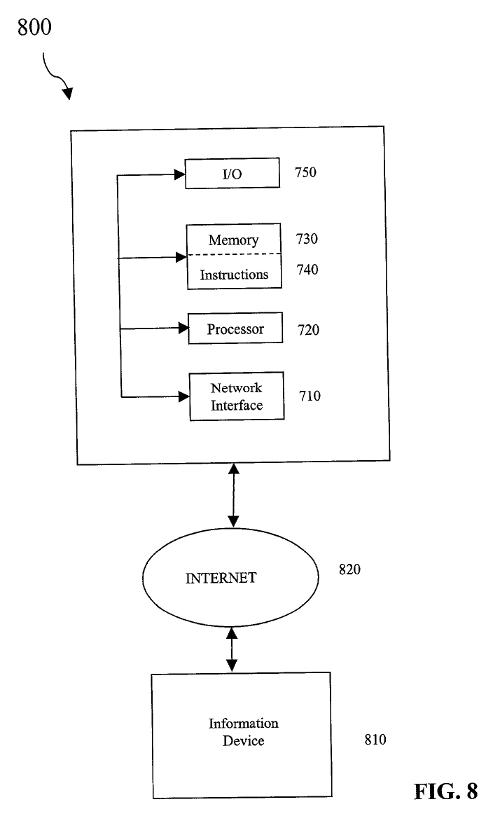

FIG. 8 is a block diagram of a network 800 that shows information device 810 in electronic communication over Internet 820 to information device 700. It will be appreciated that information device 810 may send instructions over Internet 820 to network interface 710 of information device 700. One of ordinary skill in the art will understand that information device 810 may initiate and execute method 100 of FIG. 1 from an off-site location.

Thus, embodiments of the present invention can allow cost-efficient and rapid creation and rendering of bills of materials listing identifiers for components of a part. Moreover, embodiments of the present invention can rapidly render identifiers for one or more, but less than all, components of a part. Further, embodiments of the present invention can allow easy updating of component identifiers without programming skills.

Still other advantages and embodiments of the present invention will become readily apparent to those skilled in this art from the above-recited detailed description of certain exemplary embodiments. Accordingly, the drawings and descriptions are to be regarded as illustrative in nature, and not as restrictive. For example, an alternative embodiment of method 100 can be run in batch mode, thereby allowing rapid creation and/or rendering of multiple bills of material.

What is claimed is:

1. A computer-implemented method for generating a bill of materials for a product, comprising:
iteratively determining a plurality of component identifiers from a plurality of sub-identifiers associated with an identifier for a product, each of the plurality of component identifiers associated with a component of the product; and
rendering the iteratively determined plurality of component identifiers.

2. The method of claim 1, further comprising parsing the identifier associated with the product into the plurality of sub-identifiers.

3. The method of claim 1, further comprising de-concatenating the identifier associated with the product into the plurality of sub-identifiers.

4. The method of claim 1, further comprising storing each of the plurality of component identifiers in a multi-variable table, the multi-variable table including three or more variables.

5. The method of claim 1, further comprising associating each of the sub-identifiers with a variable.

6. The method of claim 1, further comprising associating each of the sub-identifiers with a variable of a multi-variable table, the multi-variable table including three or more variables.

7. The method of claim 1, further comprising iteratively retrieving a component identifier from the plurality of component identifiers from a multi-variable table, the multi-variable table including three or more variables, each of the three or more variables associated with a sub-identifier.

8. The method of claim 1, farther comprising iteratively retrieving a component identifier from the plurality of component identifiers from a multi-variable table, the multi-variable table including three or more variables, at least one of the three or more variables associated with a sub-identifier.

9. The method of claim 1, further comprising iteratively retrieving a component identifier from the plurality of component identifier from a multi-variable table, the multi-variable table including at least three variables.

10. The method of claim 1, further comprising iteratively retrieving a first component identifier from the plurality of component identifiers from a multi-variable table, the multi-variable table including three or more variables, at least one of the three or more variables associated with a second component identifier from the plurality of component identifiers.

11. The method of claim 1, further comprising retrieving a component identifier from the plurality of component identifiers from a multi-variable table, the multi-variable table including three or more variables.

12. The method of claim 1, further comprising retrieving each of the plurality of component identifiers from a multi-variable table, the multi-variable table including three or more variables.

13. The method of claim 1, further comprising repeating said iteratively determining activity and said rendering activity for each of a plurality of products.

14. The method of claim 1, wherein the product is an industrial good.

15. The method of claim 1, wherein the product is an electrical good.

16. The method of claim 1, wherein the plurality of components include at least one of an unenclosed starter kit, an enclosure kit, a circuit breaker, a disconnect switch kit, a handle mechanism kit, a power wire kit, and a fuse block kit.

17. A computer-implemented method for generating a list of components associated withan item, comprising:
iteratively determining a plurality of components of an item from an identifier associated with the item; and
rendering the iteratively determined plurality of components.

18. A computer-readable medium containing instructions for activities comprising:
iteratively determining a plurality of component identifiers from a plurality of sub-identifiers associated with an identifier for a product, each of the plurality of component identifiers associated with a component of the product; and
rendering the iteratively determined plurality of component identifiers.

19. A system for generating a bill of materials for a product, comprising:
means for iteratively determining a plurality of component identifiers from a plurality of sub-identifiers associated with an identifier for a product, each of the plurality of component identifiers associated with a component of the product; and
means for rendering the iteratively determined plurality of component identifiers.

20. A computer-implemented method for generating a bill of materials for a product that is executed in response to electronic instructions received over the Internet from an information device, comprising:
recieving the electronic instructions;
iteratively determining in response to the electronic instructions a plurality of component identifiers from a plurality of sub-identifiers associated with an identifier for a product, each of the plurality of component identifiers associated with a component of the product; and
rendering the iteratively determined plurality of component identifiers.
